(19) United States
(12) Patent Application Publication
(10) Pub. No.: US 2017/0126876 A1
(43) Pub. Date: May 4, 2017

(54) SYSTEM AND METHOD FOR BLOCKING CALLS TO RESTRICTED NUMBERS FROM CALL CENTERS

(71) Applicant: DAVID JASSAN, MEXICO (MX)

(72) Inventor: DAVID JASSAN, MEXICO (MX)

(21) Appl. No.: 14/926,715

(22) Filed: Oct. 29, 2015

(51) Int. Cl. H04M 1/677; H04M 3/42; H04M 1/663

(52) U.S. Cl. CPC H04M 1/677; H04M 1/663; H04M 3/42102

(57) ABSTRACT

The present invention includes of a system and method to block calls to restricted numbers from call centers, in such a way that statistical data of all the calls made could be controlled, recorded and registered. Also, remote calls could be made which would be linked to a call center that also allows the monitoring of the quality of the calls made by sales agents in a call center. The sales agents can make the calls from a computer or from a land or mobile line. The system further includes a database with restricted numbers and a database with information of the clients and the recorded calls made by the agents, a centralized calls platform (CCP) with a server connected to the database which concentrates in one virtual place all the calls made by the different agents and controls the numeric menus with the corresponding options executed by an automated system of interactive voice response (IVR) that allows the platform to interact with an agent through the use of voice and touch input through a keypad, a variety of call stations and/or a central station or call center where the centralized platform is located.

### FIELD OF THE INVENTION

This invention relates, in general, to a system and method for blocking calls made by sales agents in call centers to restricted numbers, and more particularly, to a call center system and method for blocking calls made by a sales agent in such a way that the validity of the calls may be verified before linking the same. Further, to a system and method for controlling, recording and registering statistical data from every call made. It also allows the agent to make remote calls linked to a call center which also allows the monitoring of quality of the calls made by the sales agents in a call center. Also, in accordance with another embodiment of the present call center system and method, the sales agents can make calls without the need of a computer, using only a land or mobile line from a remote station which may be their home or another place.

### BACKGROUND OF THE INVENTION

Currently, when a company wishes to carry out an advertisement or promotion via telephone, it turns to the call centers to carry out the same, which has the potential that a possible client may receive multiple calls from different sales agents and even from different call centers, causing the annoyance of the client, who may resort to the government authorities, such as REUS, IFETEL, CONDUSEF, etc., to request the blocking of his/her telephone number in order to not receive more advertising calls from call centers. Still further, the government authorities may thereafter inform the companies not to make any more calls to that specific client and pursuant to legal provisions, the company may be penalized if it continues to call this client. As will be appreciated, this is a great problem for the company because although it informs the call centers that these numbers that are prohibited, it does not have direct control of all the call centers hired and these, in turn, do not have any control of the calls made by each of its sales agents, and when a sales agent calls one of these prohibited telephone numbers, the fine is imposed on the company, and the same is unable to identify which of the call centers hired made the call the prohibited number.

Also, when a company launches an advertising campaign in which it offers a product or a promotion, it may hire multiple contact agencies or call centers or telemarketing agencies, which may be large, small or of a single person, which currently act independently from one another. Thus, there exists a need in the art to centralize the operation of the multiple agencies, to establish control amongst them.

The present invention seeks to overcome these difficulties by enabling a system and method to concentrate the calls from the sales agents in call centers in a centralized calls unit, whereby this centralized calls unit is connected to a database of prohibited numbers and are able to block calls from any sales agent from any call center to these telephone numbers, thereby avoiding possible fines to the company.

### SUMMARY OF THE INVENTION

It is an object of the present invention to provide a call center system.

It is another object of the present invention to provide a call center system and method for blocking calls made by sales agents in call centers to restricted numbers.

It is another object of the present invention to provide a call center system and method that blocks calls made by a sales agent in such a way that the validity of the calls may be verified before linking the same.

It is another object of the present invention to provide a call center system and method that enables the recording and registering of statistical data from every call made.

It is another object of the present invention to provide a call center system and method that allows the agent to make remote calls linked to a call center which also allows the monitoring of quality of the calls made by the sales agents in a call center.

It is another object of the present invention to provide a call center system and method that the sales agents can make calls without the need of a computer, using only a land or mobile line from a remote station which may be their home or another place.

These and other objectives of the present invention, and their preferred embodiments, shall become clear by consideration of the specification, claims and drawings taken as a whole.

### BRIEF DESCRIPTION OF THE DRAWINGS

FIG. 1 is a flowchart showing the method to carry out calls from this invention, according to one embodiment of the present invention.

FIG. 2 is a diagram showing the system of this invention, in accordance with one embodiment of the present invention.

FIG. 3 is a flowchart showing the method for blocking calls from a call center to a restricted number from this invention, also in accordance with one embodiment of the present invention.

### DETAILED DESCRIPTION

The system of this application has the advantage of being able to block calls made by sales agents from call centers to restricted numbers and at the same time, concentrate all the calls from the different call centers in one centralized call modules to be able to control and identify the calls made to prohibited numbers and also allows the sales or campaign agents to make calls to the clients from a computer or a land or mobile line, since these are work stations.

A database with telephone numbers of clients who do not wish to receive telephone calls, these telephone numbers are stored in a database as blocked numbers for the different call center companies. This database may be stored in two ways, the first through the telephone numbers reported by the government bulletins or notices, such as REUS, IFETEL or CONDUSEF, etc., as these numbers are reported by government authorities and are stored in a database as blocked numbers. The second method of storing such blocked numbers is by storing the telephone numbers of the clients who directly notify the sales agents that he/she no longer wishes to receive any more promotions, advertising or information, and if so, the sales agent chooses an option from a menu through IVR to include the telephone number of the client in the database of blocked numbers.

Regardless of the method employed to store the numbers to be blocked, when the sales agent from any of the call center dials manually or automatically the telephone number of a client from a database of possible clients, a processor which compares the telephone number of the client chosen with the telephone numbers from the data base of blocked numbers, verifies that it is a valid number. If the telephone number dialed belongs to the database of blocked numbers, a recording is activated, informing the sales agent that it is not possible to dial this number because the telephone number is blocked and the call ends, and if the telephone number does not appear in the data base, then the call is linked with the client.

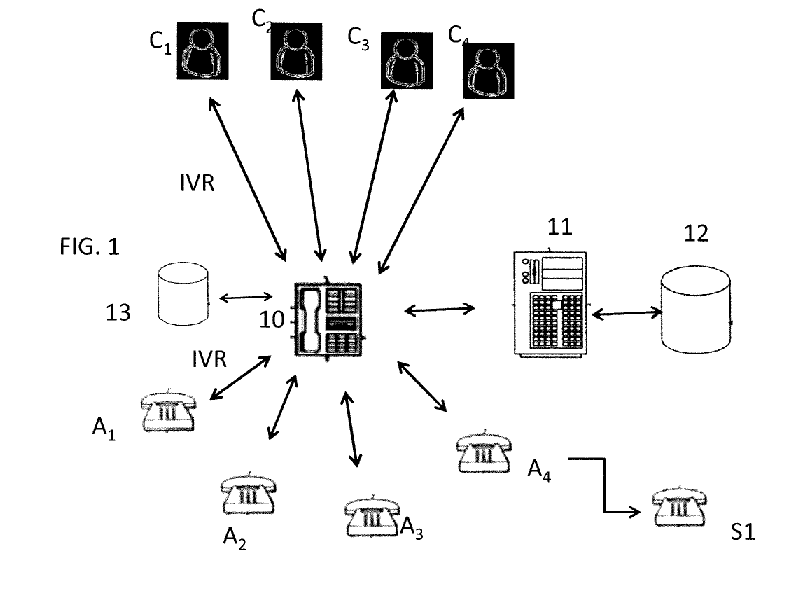

In one preferred embodiment shown in FIG. 1, the present system includes: a first database (12) with information of the clients and the recorded calls made by the agents; a second database with prohibited telephone numbers (13) to block their dialing; a centralized unit of CCP calls (11) with a server connected to the database with prohibited telephone numbers and which may also be connected to the database of the clients (12), said platform concentrates all the calls made by the different agents (A₁, A₂, A₃, A₄, etc.) in one place and controls the numeric menus with the corresponding options executed by an automated system of interactive voice response (IVR), which allows the platform (11) to interact with an agent through the use of voice and touch input; a variety of call stations, which may or may not be remote/distant (A₁, A₂, A₃, A₄, etc.) each one with a land or mobile line or with a computer; a central station or centralized calls unit (10) where the centralized platform is organized (11).

Also, the system of the present embodiment includes a client relationship management system, which encodes the interactions between the agent and the final client, thereby providing feedback with regards to how to focus the sales agent to strengthen and increase the productivity when contacting new clients.

In accordance, therefore, with present invention, the method to block the calls made by the sales agents of call centers to blocked numbers from this invention includes the following steps:

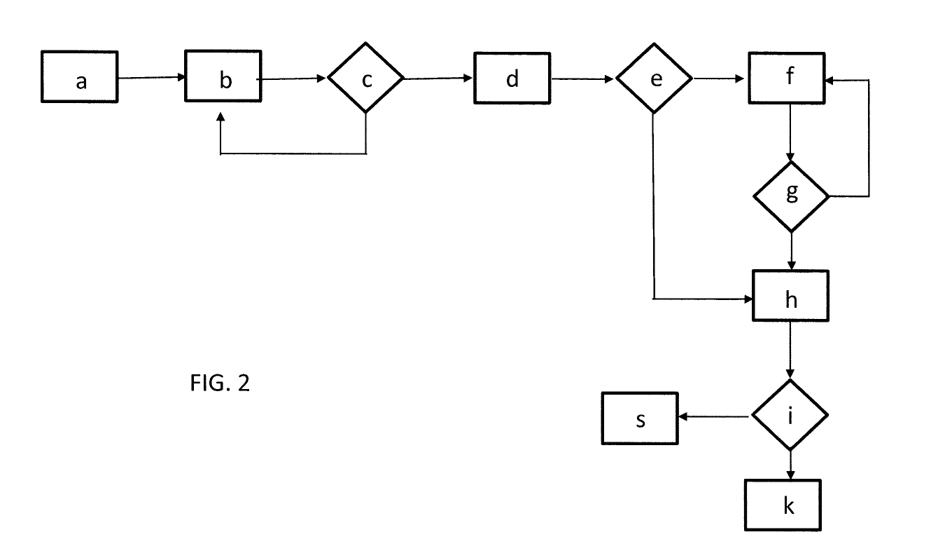

As shown in FIG. 2, step (a) a sales agent (A₁, A₂, A₃, A₄, etc.) is connected with a centralized calls unit from a land or mobile line or a computer, in a remote manner or not.

b) The centralized calls unit through an automated system of interactive voice response (IVR) asks the sales agent for his personal identification number (PIN).

c) The centralized calls platform determines if the PIN is correct.

d) If the sales agent entered the correct PIN, the centralized calls platform CCP (11) updates the notifications corresponding to the agent's working day.

If the agent's PIN is incorrect, the agent, through the IVR, is required to enter the same again and after three failed attempts, the call is disconnected from the call center.

e) The centralized calls platform determines if there are any notifications from a supervisor for the sales agent.

f) If there are any notifications, the existence of messages is communicated to the agent through the IVR and these messages are transmitted, that is, the CCP platform (11) through the IVR informs the sales agent of the existence of inexistence of messages or notifications left by a supervisor or superior official in a voice mail assigned to the sales agent.

As will be appreciated, if there are no notifications in the voice mail, the agent proceeds to the manual or automatic dialing of the telephone number of a client chosen from a database.

g) The centralized calls platform, through the IVR questions the agent through a menu with predetermined numeric options about listening to the voice mail messages again or to access dialing the telephone of a client (C₁, C₂, C₃, C₄, etc.).

h) If the sales agent (A₁, A₂, A₃, A₄, etc.) chooses to access the option of dialing, the CCP platform (11) chooses the telephone number of a client (C₁, C₂, C₃, C₄, etc.) selected from a database (12) which is connected to the CCP platform (11), said CCP platform (11) chooses the client (C₁, C₂, C₃, C₄, etc.) in a predetermined order or randomly from a database (12).

The CCP platform (11) determines if the agent requires information from the client before connecting and if so, it provides the agent (A₁, A₂, A₃, A₄, etc.) the necessary information of the client (C₁, C₂, C₃, C₄, etc.) from the database (12) through the IVR.

If the sales agent chooses to listen to the messages again, the centralized calls platform transmits the recording of his messages once again.

i) The CCP platform (11) compares the chosen telephone number from a client with the telephone numbers that make up a database of restricted, prohibited or blocked numbers (13).

j) If the chosen telephone number is found within the database of prohibited numbers, a voice message is sent to the sales agent, informing him/her that the number dialed is blocked and the call is ended.

The database with telephone numbers that are prohibited, that is, those blocked numbers, are communicated to the different call center companies in two ways: the first way comes from the telephone numbers reported by the government entities directly, such as being communicated from government agencies such as REUS, IFETEL or CONDUSEF, etc. These numbers reported by the government authorities are stored in a database as blocked numbers. The second manner of communicating such numbers are be conveying the telephone numbers of the clients who directly notify the sales agent that they no longer wish to receive more promotions, advertising or information. In such cases, the sales agent chooses an option from a menu through IVR to include the telephone number from the client to the database of prohibited numbers.

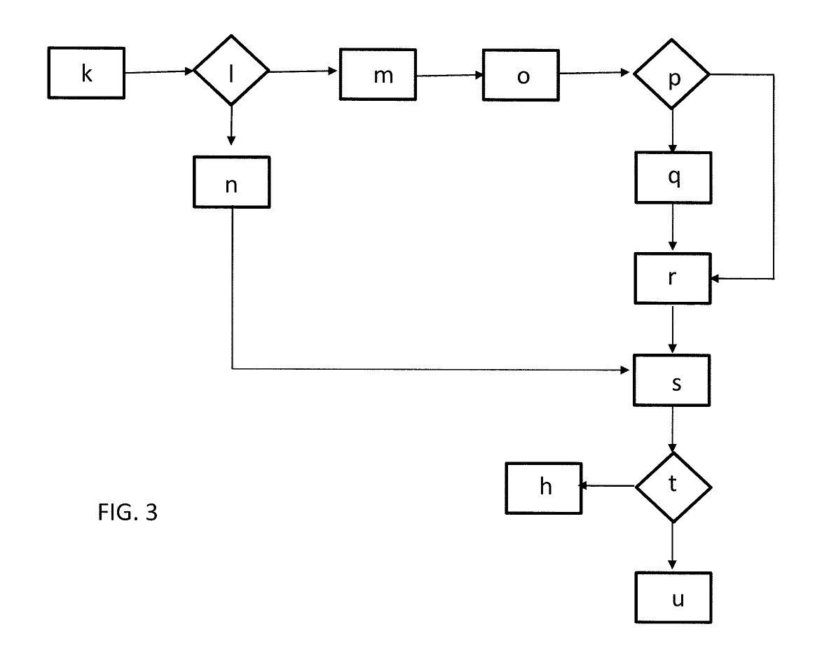

As shown in FIG. 3, step (k), if the number dialed by the agent is not found in the database of prohibited numbers, he/she may proceed with the call.

l) It is determined if the call is successfully connected with the client.

m) If the agent's (A₁, A₂, A₃, A₄, etc.) call is successfully connected with the client (C₁, C₂, C₃, C₄, etc.), the centralized calls platform begins the recording of the call and the agent offers the product or promotion to the client.

n) If the call is not successfully connected, the agent, through the platform (CCP), classifies the reason why the call was not connected successfully, identifies the cause through a menu of numeric options and ends the call, the CCP platform (11) detects the reason assigned to a numeric option different for the possible causes, such as, the client is not responding, he/she is busy, not answering or wrong number.

o) After the agent offers the client the product, the agent classifies the result through the IVR, that is, once the agent speaks to the client, the agent, through the IVR, selects from a menu of numeric options, the corresponding option identifying the result of the call, said menu of numeric options provided by the platform (CCP) through the IVR includes, for example: the number 3 to identify a sale, the number 4 to determine that the client is not interested in the offer, the number 5 to indicate they must call at a later time, the number 6 to identify the existence of an answering machine, etc., and another number to include the telephone number of the client in the database of blocked numbers as per request of the client, it is important to note that these numeric options are only written as an example, they may be different.

p) The agent determines if it is necessary to record a voice message with regards to the call made.

q) If the agent selects the option to record a voice message, he/she must record a voice message associated to the call just made so that a supervisor may consult the same subsequently.

If the agent does not consider it necessary to leave a voice message, he/she shall select the numeric option to end the call.

It is also possible for the agent to deem necessary to transfer the call through the IVR menu to a supervisor to provide the client with additional information or just register a successful sale.

r) The (CCP) platform ends the recording of the all and stores the same in a database.

s) The call is ended.

t) The agent enters a menu of numeric options via IVR to select if he/she wishes to exit the centralized calls platform or if he/she wishes to begin dialing the telephone number of another client form the database.

If the agent chooses to begin dialing the telephone number of another client from the data base, he/she returns to step h).

u) If the agent wishes to exit the centralized calls platform, he/she automatically disconnects from the platform and the call is dropped from the telephone network.

Subsequently, the platform (CCP) automatically sends the recording of the call to a database with the information of the call and it is placed in an electronic portal, where a supervisor can consult the calls recorded in a database associated with the electronic portal.

As will also be appreciated, the database where the calls recorded are stored may be the same database of the clients or they could be two different databases.

It is one important aspect of the present invention that the IVR gives the agent the numeric option to address a help table when the agent has any question or technical problem, and if this is the case, he/she shall be redirected to a help table where an operator will assist his/her call or he/she may leave a message if the operator is not available.

The operation of the system advantageously begins when the agent (A₁, A₂, A₃, A₄, etc.) is connected to a centralized unit, which through the IVR asks for a key, code or extension from the agent, the agent dials the key and the operator reads off a menu of options, such as: ‘are you going to work?’; ‘begin dialing?’. Once the agent dials in the option, the operator chooses a client (C₁, C₂, C₃, C₄, etc.) from a database in a predetermined order or randomly, as required, and compares the telephone number of the client selected with the numbers included in a database of restricted, prohibited or blocked numbers. If the agent needs information from the client, the operator provides the agent with information before calling the client and carries out the call to the client, recording the conversion between the client and the agent. Thereafter, and once the call has ended, the agent is returned to a menu of options and the automated operator gives him the options of choosing between a sale, wrong number, not answering, does not accept the product, etc. As discussed, the conversion between the agent and client is recorded and stored in a database of calls made, and once the agent's call ends, the agent is connected to a second operator who may or may not speak to the client, and/or to register the sale or monitor the quality of the call.

Later, as a supervisor downloads and consults the calls in an interactive portal, the agent may include voice massages for the supervisor once finishing the conversation with the client. The recording of the call includes details, such as agent, date, time, call, recording of the call, calling telephone number, called telephone number, and sends them to a database which puts them at the disposal of the supervisor or manager, in such a way so that the supervisory may carry out an analysis or monitoring of the calls.

For its part, the centralized calls platform (CCP) advantageously concentrates in a virtual place all the calls made by the different agents.

The automated interactive voice response (IVR) system is a technology that allows a computer to interact with an agent through the use of voice and touch input via de keypad.

The client relationship manager (CRM) is a system that encodes the interactions between the agent and the final client, providing important feedback about how to focus the sales agent to strengthen the increase of productivity when contacting new clients.

1. A method for blocking calls to restricted numbers from call centers, said method comprising the steps of:
connecting a sales agent with a centralized call module from one of a land line or mobile line or a computer;
utilizing said centralized call module to identify said sales agent;
permitting said sales agent to accesses an option of dialing, and thereafter manually or automatically choosing a telephone number of a client selected from a client database;
enabling said centralized call module to utilize a centralized call platform CPP in order to compare said telephone number of said selected client with a telephone number database comprising said restricted telephone numbers;
wherein if said telephone number of said selected client is found within said database of said restricted telephone numbers, an interactive voice response (IVR) voice message is sent to said sales agent, indicating that said telephone number is restricted, and said call is ended; a
wherein if said telephone number of said selected client is not found within said database of said restricted telephone numbers, said telephone number is dialed to initiate a call and a recording of said call is initiated automatically from said centralized call platform.

2. The method according to claim 1, further comprising the step of:
with said centralized call platform, providing to said sales agent a menu containing a plurality of options to classify said call.

3. The method according to claim 2, wherein:
said plurality of options include at least adding said telephone number to said telephone number database comprising said restricted telephone numbers.

4. The method according to claim 3, wherein:
adding said telephone number to said telephone number database comprising said restricted telephone numbers is accomplished using an interactive voice response system.

5. The method according to claim 1, wherein:
said centralized call module is configured to receive, manage and record calls from a plurality of different call centers.
